(19) United States
(12) Patent Application Publication
(10) Pub. No.: US 2025/0310942 A1
(43) Pub. Date: Oct. 2, 2025

(54) CARRIER WAVE AND DEVICE TO READER TRANSMISSION FOR AMBIENT INTERNET OF THINGS

(71) Applicant: Apple Inc., Cupertino, CA (US)

(72) Inventors: Huaning Niu, San Jose, CA (US); Haitong Sun, Saratoga, CA (US); Wei Zeng, Saratoga, CA (US); Sigen Ye, San Diego, CA (US); Ankit Bhamri, Haar,Bavaria-Bayern (DE); Dawei Zhang, Saratoga, CA (US); Hong He, San Jose, CA (US)

(21) Appl. No.: 19/069,712

(22) Filed: Mar. 4, 2025

Related U.S. Application Data
(60) Provisional application No. 63/573,223, filed on Apr. 2, 2024.

(51) Int. Cl. H04W 72/0453; H04L 5/00

(52) U.S. Cl. CPC H04W 72/0453; H04L 5/0007

(57) ABSTRACT

Systems, methods, processors, and circuitries are provided for an ambient IoT system. In one example, a carrier wave node device of an ambient IoT system includes radio frequency (RF) front end circuitry and a processor. The processor is configured to, when executing instructions stored in a memory, determine one or more carrier wave frequencies associated with a configured device-to-reader (D2R) channel of an ambient IoT system bandwidth; and control the RF front end circuitry to transmit a carrier wave having frequency components corresponding to the one or more carrier wave frequencies.

### CROSS-REFERENCE TO RELATED APPLICATIONS

This application claims the benefit of priority from U.S. Provisional Patent Application No. 63/573,223, filed on Apr. 2, 2024 and entitled CARRIER WAVE AND DEVICE TO READER TRANSMISSION FOR AMBIENT INTERNET OF THINGS, the contents of which are hereby incorporated by reference in their entirety.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks may be developed to implement fifth generation (5G) or new radio (NR) technology, sixth generation (6G) technology, and so on. Such technology may include solutions for enabling user equipment (UE) and network devices, such as base stations, to communicate with one another.

Internet of Things (IoT) networks include low power/capability IoT devices that periodically transmit signals carrying simple payloads to reader devices. A feature of such networks and devices may include a backscatter transmission scheme in which an IoT device modulates a received carrier wave to encode transmit data and the modulated reflection of the carrier wave is received by the IoT reader device.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIGS. 1A and 1B illustrate two example backscatter communication systems.

FIG. 2 illustrates an example ambient IoT system, according to various aspects disclosed herein.

FIG. 3 illustrates an example ambient IoT system, according to various aspects disclosed herein.

FIGS. 4 and 4A-4F illustrate an example coding scheme, in according to various aspects disclosed herein.

FIG. 5 illustrates an example ambient IoT system configuration, according to various aspects disclosed herein.

FIGS. 6A, 6A(a), 6A(b), 6A(c) illustrate example ambient IoT system configurations, according to various aspects disclosed herein.

FIG. 6B illustrates an example ambient IoT system configuration, according to various aspects disclosed herein.

FIG. 7 illustrates an example ambient IoT system configuration, according to various aspects disclosed herein.

FIG. 8 illustrates an example ambient IoT system configuration, according to various aspects disclosed herein.

FIGS. 9A and 9B illustrate example ambient IoT system configurations, according to various aspects disclosed herein.

FIG. 10 is a flow diagram outlining an example method for transmitting an ambient IoT carrier wave, according to various aspects disclosed herein.

FIG. 11 is a flow diagram outlining an example method for receiving and decoding a device to reader (D2R) signal, according to various aspects disclosed herein.

FIG. 12 is a flow diagram outlining an example method for transmitting a D2R signal, according to various aspects disclosed herein.

FIG. 13 is a diagram of an example wireless network, according to various aspects disclosed herein.

FIG. 14 is a diagram of an example of components of a device according to various aspects disclosed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

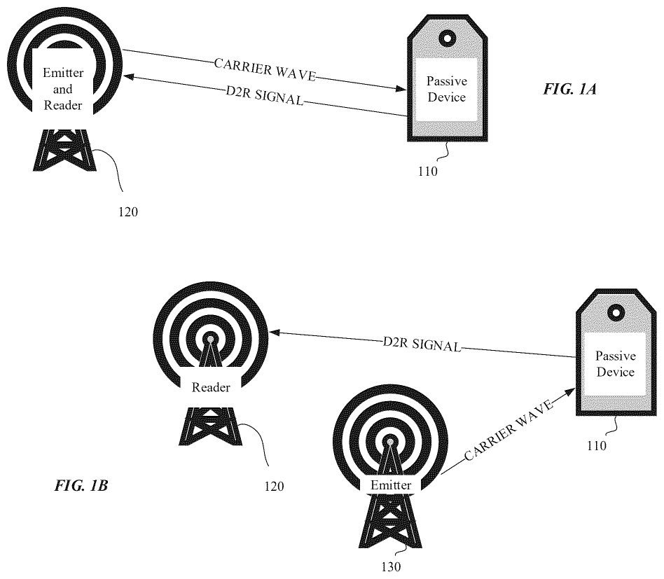

FIG. 1A illustrates an example backscatter communication system that includes a passive device 110 and an emitter and reader device 120. The passive device 110 may be broadly characterized as passive by its lack of power storage capability and related circuitry for generating a radio frequency (RF) transmission carrier signal. The emitter and reader device 120 transmits an RF carrier wave to the passive device 110. The RF carrier wave may be transmitted continuously or periodically to initiate a data transmission by the passive device 110. A backscatter transceiver in the passive device 110 modulates the RF carrier wave to encode transmit data and reflects the modulated carrier wave back to the reader device 120. The reflected modulated carrier wave is called a device to reader (D2R) signal. In this manner the passive device 110 does not need to generate an RF transmission carrier signal using its own power. This technique allows for the passive device to operate without a significant (or any) power source.

Several drawbacks to the backscatter communication system illustrated in FIG. 1A have prevented wider application of these techniques outside of inventory control, tracking devices, and medical telemetry to the wider field of Internet of Things (IoT). One important drawback is the limited range of backscatter communication, especially in noisy or dense deployment scenarios, making conventional backscatter communication techniques less attractive for IoT applications.

Ambient backscatter communication techniques are an extension of the example backscatter communication system illustrated in FIG. 1A in which the passive devices may modulate and reflect carrier waves received from an emitter device other than the reader device. FIG. 1B illustrates an example ambient backscatter communication system in which a passive device 110 receives a carrier wave from an emitter device 130 and modulates the carrier wave to reflect the D2R signal toward the reader device 120. In FIG. 1B, the emitter device 130 is illustrated as a base station/transmission reception point (TRP) type device and the emitter device 130 is illustrated as another base station/TRP. However, in other examples, different types of devices (nearby television broadcast tower, WiFi access point (AP), and so on) may serve as the emitter device.

Ambient backscatter communication provides several benefits as compared to backscatter communication in which the same device acts as emitter and reader. For example, interference with the D2R signal at the reader device 120 is significantly reduced because the reader is no longer the source of the carrier wave. The D2R signal does not suffer from attenuation due to traveling the round trip distance with respect to a distant reader device. Emitter devices 130 may be placed in closer proximity to the passive device 110 than the reader device 120, boosting the communication range. Further, the passive device 110 may act independently and transmit data without initiation from a reader device 120 as long as a sufficiently strong carrier wave is being received from an emitter device 130.

The frequencies in which ambient IoT device operates may significantly impact the range of backscatter communication due to interference. It may be beneficial to use licensed New Radio spectrum for backscatter communication as interference from unlicensed devices may be limited in licensed spectrum. Further, the NR network may be able to allocate communication resources in a manner that limits interference with backscatter communication occurring in a configured ambient IoT system bandwidth. Disclosed herein are solutions for determining carrier waves, coding schemes, and channel allocations for an ambient IoT system. While in some contexts the disclosed systems operate using licensed spectrum, the solutions presented herein are equally applicable to ambient IoT devices operating in unlicensed spectrum.

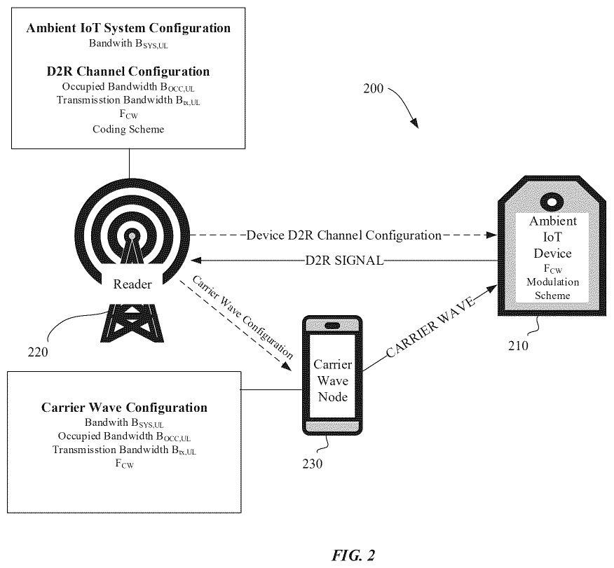

FIG. 2 illustrates an example ambient IoT system 200 that is configured for operation in licensed spectrum to collect D2R data from at least one ambient IoT device 210. The system includes a reader device 220 and a carrier wave node device 230 as well as the IoT device 210. The ambient IoT system 200 operates according to an ambient IoT system configuration that includes a system bandwidth B_{SYS,UL} within which one or more D2R channels are configured. The individual D2R channels are characterized by an occupied bandwidth B_{OCC,UL}, a transmission bandwidth B_{tx,UL}, a carrier wave frequency F_{CW}, and a coding scheme that includes a code type (e.g., Manchester, FM0, and so on) and a coding chip rate. The ambient IoT system configuration may be set by standard or signaled to the system 200 by higher layer signaling.

In some examples, the reader device 220 configures the ambient IoT device 210 with respect to at least some aspects of the D2R channel configuration. For example, the reader device may configure a data rate and coding chip rate associated with the D2R channel. This configuration may be made by way of a query message transmitted in a physical channel associated with reader to device (R2D) data transmission, such as a physical R2D data channel (PRDCH).

The reader device 220 receives and decodes the D2R signal based on the ambient IoT system configuration for a D2R channel allocated for the ambient IoT device. The reader device 220 may transmit a carrier wave configuration to the carrier wave node device 230 that includes selected elements of the ambient IoT system configuration such as the system bandwidth, the D2R channel's occupied bandwidth and transmission bandwidth, and the carrier frequency of the desired carrier wave. A configured Uu channel between the reader device 220 and the carrier wave node device 230 may be used to transmit the carrier wave configuration. In other examples the carrier wave node device 230 receives the carrier wave configuration from another network entity or the carrier wave configuration may be set by standard.

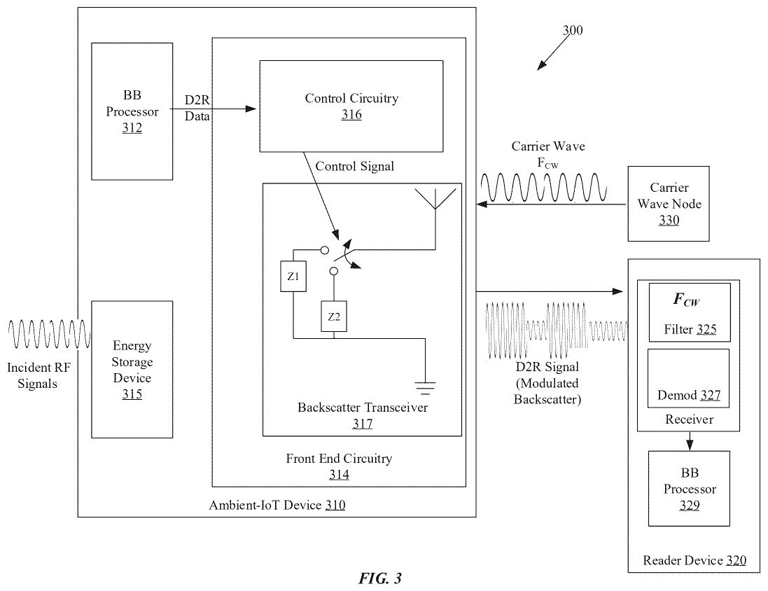

FIG. 3 is functional block diagram of an example ambient IoT system 300 that includes ambient IoT device 310, carrier wave node device 330, and reader device 320. The ambient IoT device 310 includes a baseband processor 312, front end module 314, and an energy storage device 315. The energy storage device 315 is capable of capturing and storing the energy of incident RF signals received from ambient sources such as television, radio, or WiFi signals and/or carrier waves received from a carrier wave node device. The storage capacity of the energy storage device 315 supports operation of the baseband processor 312 as well as the control circuitry 316. As will be disclosed in more detail below, the control circuitry 316 encodes D2R data generated by the baseband processor 312 and controls a backscatter transceiver 317 to modulate a received carrier wave based on the encoded D2R data to generate a D2R signal that is reflected for reception by the reader device.

The backscatter transceiver 317 is tuned to a particular D2R channel. In some examples, the ambient IoT device 310 may include amplifier circuitry for amplifying the D2R signal and increasing the communication range. In these examples, the energy storage device 315 may need to have additional storage capacity as compared to ambient IoT devices that do not include amplifier circuitry.

The reader device 320 includes a receiver with filter circuitry 325 that cancels signal components outside the desired D2R channel. The filter circuitry 325 may include filters that filter based on the center frequencies of the undesired D2R channels and/or filters that pass signal components within the desired D2R channel. The receiver also includes demodulation circuitry 327 that demodulates the filter signal. The reader device 320 includes a baseband processor 329 that decodes the demodulated signal based on the coding scheme (e.g., Manchester or FM0 coding) and the coding chip rate associated with the D2R channel. While the ambient IoT system 300 features a separate carrier wave node device 330 and reader device 320, in some examples, the same device may serve as both carrier wave node device and reader device while performing the functions ascribed to both devices herein.

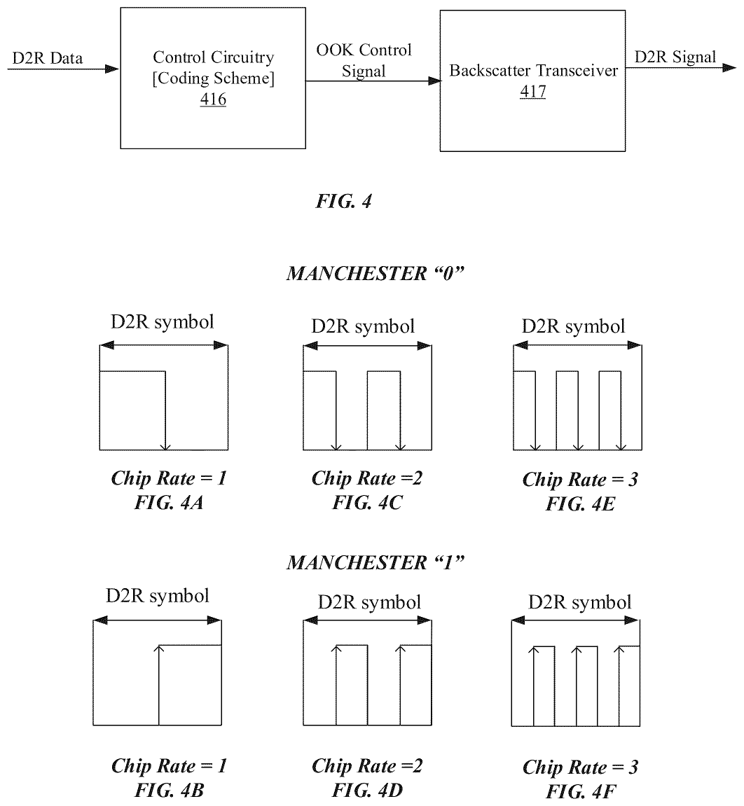

FIG. 4 illustrates an example processing by an ambient IoT device of D2R data into a D2R signal. D2R data is provided to control circuitry 416 which generates an on-off keying (OOK)-1 control signal based on a coding scheme. The coding scheme defines how 0s and 1s of the D2R data are encoded in the D2R signal. The OOK-1 control signal controls the backscatter transceiver 417 to transmit the encoded D2R data by either reflecting or not reflecting the received carrier wave and in this manner generates the D2R signal. As shown in FIG. 3, the OOK-1 control signal may control a switch that connects either a high impedance or a low impedance between the backscatter transceiver input and ground.

FIGS. 4A-4F illustrate a Manchester coding scheme according to three different coding chip rates. A coding chip is a basic unit of a given coding system in which a value of 1 or 0 may be encoded. As seen in FIGS. 4A and 4B, in Manchester coding, a 0 is encoded by a falling edge midway through a coding chip (e.g., [1 0]) and a 1 is encoded by rising edge midway through a coding chip (e.g., [0 1]). In another configuration of Manchester coding, [0 1] may be used to encode a 0 and [1 0] may be used to encode a 1. The coding scheme may be performed according to different chip rates, which define the number of repeated chips are used to encode a symbol. FIGS. 4C and 4D illustrate Manchester coded 0 and 1, respectively, according to a chip rate of 2. FIGS. 4E and 4F illustrate Manchester coded 0 and 1, respectively, according to a chip rate of 3. Other codes may be used by the ambient IoT device in other examples. Line codes such as Manchester or FM0 are well suited for use in a simple IoT device without a sophisticated clock because the rising and falling edges used to encode the data embed the clock signal in each encoded bit.

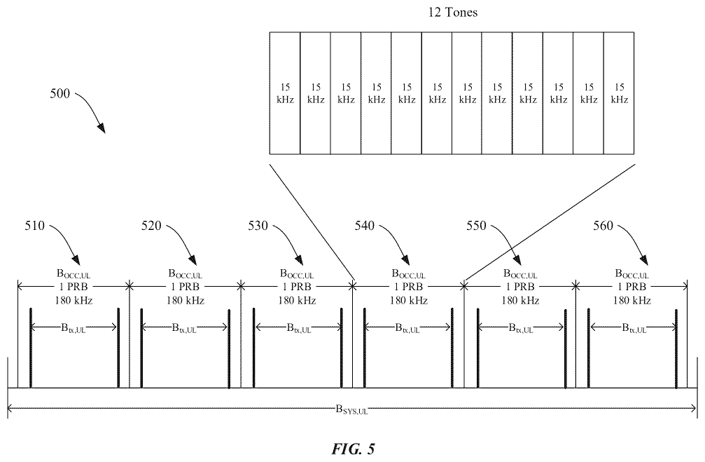

FIG. 5 illustrates an example ambient IoT system configuration 500 in which a system bandwidth B_{SYS,UL} includes six D2R channels 510, 520, 530, 540, 550, 560. Each D2R channel has an occupied bandwidth B_{OCC,UL} of 1 physical resource block (PRB) or 180 kHz (at 15 kHz subcarrier spacing). Wider D2R channels may be used in other ambient IoT system configurations. Each D2R channel has a transmit bandwidth B_{tx,UL} that is narrower than the occupied bandwidth to reduce interference. In the illustrated example, although the D2R transmission is not an orthogonal frequency division multiplexing (OFDM) transmission, because the channel occupies the 180 kHz bandwidth, each D2R channel spans 12 New Radio (NR) orthogonal frequency division multiplexing (OFDM) tones, each comprising 15 kHz.

Different types of carrier waves may be considered for use in an ambient IoT system. Sinusoidal carrier waves may be employed or an OFDM carrier wave, similar to a downlink (DL) wake up signal (WUS), may be employed.

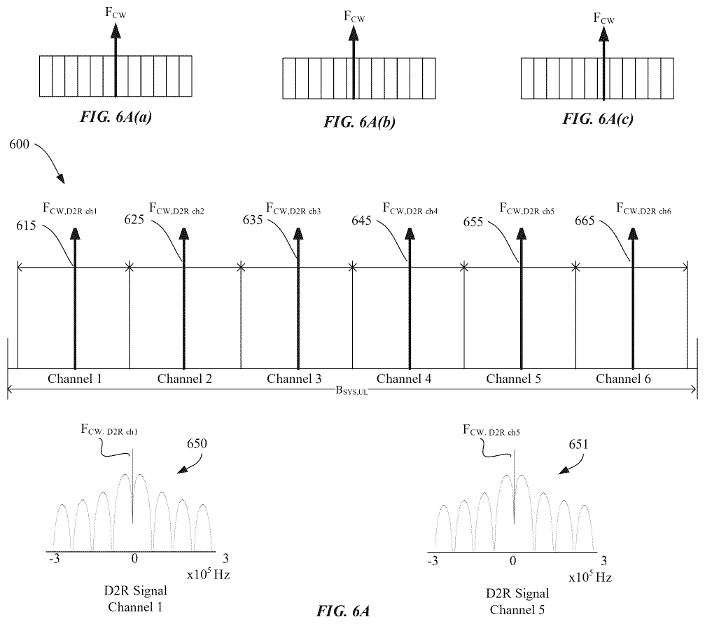

FIG. 6A illustrates an example ambient IoT system configuration 600 in which six single-tone sinusoidal carrier waves 615, 625, 635, 645, 655, 665 are defined, one for each D2R channel. The carrier wave for each D2R channel has a different carrier wave frequency Few. Different carrier wave node devices may transmit the carrier waves for different D2R channels. In this example, the coding chip rate for each D2R channel may be selected as the same as the symbol rate or set as a chip rate of one.

The carrier wave frequency for each D2R channel may be defined as the center frequency of the D2R channel as shown in FIG. 6A(a). It is noted that this center frequency is not an NR OFDM tone. In the case of OOK or other amplitude shift keying (ASK), the carrier wave is located at the DC, as can be seen by the example D2R signals 650, 651 which correspond to the modulated carrier wave of D2R channels 1 and 5, respectively. The D2R signals may be two sided (e.g., including negative frequency) as shown when the ambient IoT device is simple. The reader device will employ filters to filter out D2R signal components outside the range shown in signals 650, 651. The passband of the filter may be the D2R signal bandwidth and the null of the filter may correspond to the carrier wave frequency.

In other examples, the carrier wave frequency may be defined based on one of the two NR OFDM tones adjacent to the center frequency of the D2R channel. FIG. 6A(b) illustrates a carrier wave frequency corresponding to NR OFDM tone 6 and FIG. 6A(c) illustrates a carrier wave frequency corresponding to NR OFDM tone 7. Using an NR OFDM tone as the carrier wave frequency may simplify tuning for an NR configured device being used as a carrier wave node device (e.g., such as a UE).

FIG. 6B illustrates a variation to improve carrier wave interference nulling by the reader device. To achieve the improvement, the symbol duration is doubled (i.e., the overall data rate is reduced by half) and the resulting D2R signals 650′, 651′ for channels 1 and 5, respectively are illustrated. This wider D2R signal allows for less sharp filtering at the reader device.

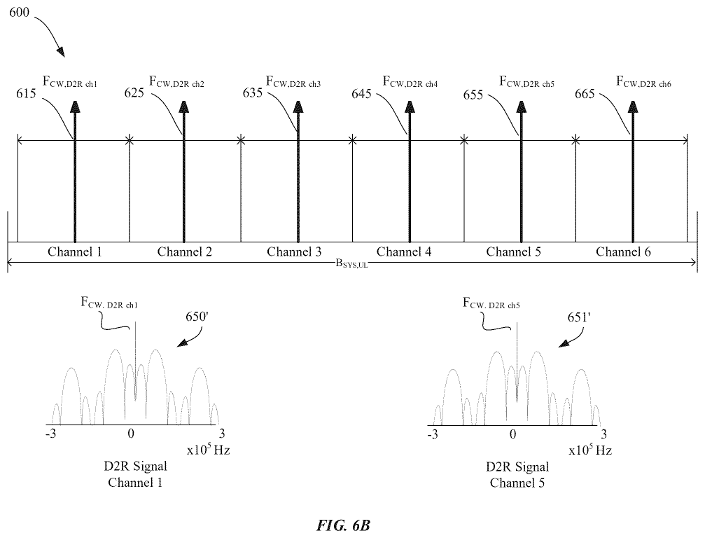

FIG. 7 illustrates an example ambient IoT configuration 700 in which one single-tone sinusoidal carrier wave is defined for the ambient IT system. The carrier wave frequency is defined at the center frequency of the system bandwidth. With this manner of defining the carrier wave for the ambient IoT configuration, a single carrier wave node device may transmit the carrier wave for multiple D2R channels. To distinguish D2R signals that are reflections of the same carrier wave, different coding chip rates are used for different channels. In the illustrated example, a coding chip rate of 1 is used for channel 1, a coding chip rate of 2 is used for channel 2, and a coding chip rate of 3 is used for channel 3. This results in the D2R signals 753, 755, 757 which correspond to D2R channels 1, 2, and 3, respectively. The number of channels that may be distinguished based on coding chip rate may be limited by the fasted chip rate supported by the control circuitry.

The D2R channels may separated into two parts when one single-tone carrier wave is used for the entire ambient IoT system. Channel 1 occupies the two configured D2R channels on either side of the carrier wave frequency. Channel 3 occupies the two configured D2R channels at either edge of the system bandwidth. Channel 2 occupies the two remaining configured D2R channels. This reduces the number of channels supported by a given ambient IoT system bandwidth, but may simplify the filtering performed by the reader device when D2R channel 1 is not used as the filtering will not need to be as sharp as is in some of the other examples.

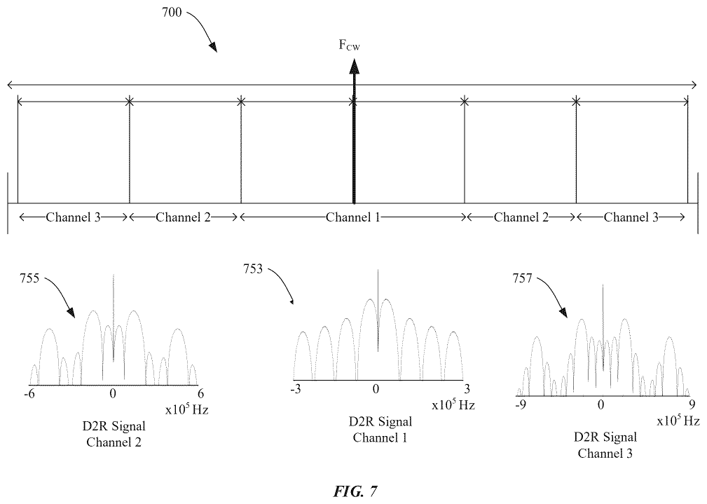

FIG. 8 illustrates a hybrid ambient IoT configuration 800 in which the system bandwidth is divided into portions (e.g., 2 as illustrated in FIG. 8) and one single-tone sinusoidal carrier wave is defined for each system bandwidth portion. The coding of the D2R data by the ambient IoT device and the filtering of the D2R signal at the reader device may be performed as described with respect to FIG. 7. This hybrid configuration combines the benefit of transmitting a single carrier wave for multiple channels without requiring the excessively high coding chip rates that would be necessary distinguish between all channels in the overall system bandwidth.

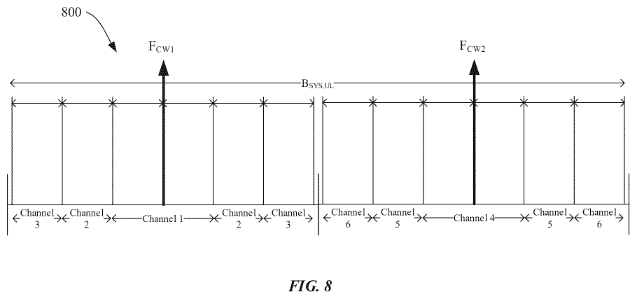

FIG. 9A illustrates an example ambient IoT configuration 900 in which a multi-tone carrier wave is used that covers the entire ambient IoT bandwidth. The multi-tone carrier wave includes a carrier wave frequency component (or tone) at the center frequency of each of multiple D2R channels. As compared to the examples illustrated in FIG. 6A and FIG. 6B, in the example of FIG. 9A, the same carrier wave node device transmits the multi-tone carrier wave rather than a separate carrier wave node device transmitting each frequency component of the carrier wave in the ambient IoT system bandwidth.

In the example illustrated in FIG. 9A, the carrier wave transmitted by the carrier wave node includes carrier wave frequency components at center frequencies of all configured D2R channels, however, in some examples, the multi-tone carrier wave may include carrier wave frequency components at the center frequencies of a subset of the configured D2R channels and/or wider multi-tone channels may be defined. FIG. 9B illustrates an example configuration 901 in which the ambient IoT system bandwidth is divided into two channels, each comprising 3 PRBs. A multi-tone carrier wave has carrier wave frequencies located at the center frequency (see FIG. 6A for alternatives) of each PRB.

In both examples, the resulting D2R signal occupies a wider bandwidth because multiple carrier wave frequency components are modulated by the ambient IoT device. This may improve coverage by providing higher frequency diversity.

Instead of a sinusoidal carrier wave, in some examples an OFDM carrier wave is used. The carrier wave may carry sequence of symbols that are encoded using OOK-1 or OOK-4. The ambient IoT device modulates a 0 or 1 onto each symbol, for example by either reflecting the symbol or not in the D2R signal. In this manner, a existing OFDM DL signal such as a DL WUS signal may be used as a carrier wave. However, this approach would require that the ambient IoT device be synchronized to the OFDM symbol timing which may add complexity to the operations to be supported by the ambient IoT device.

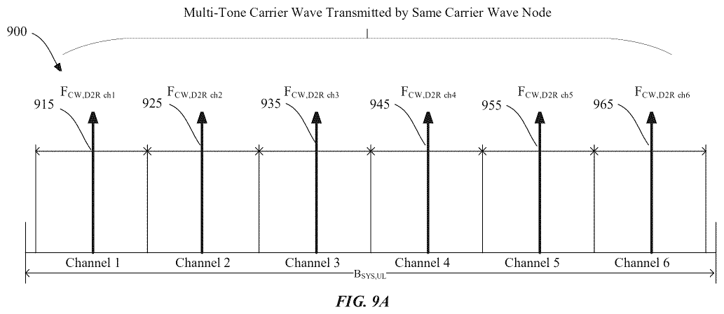

FIG. 10 is a flow diagram outlining an example method 1000 for transmitting an ambient IoT carrier wave. The method 1000 may be performed by a carrier wave node device 230 of FIG. 2 or 330 or FIG. 3. The method includes, at 1311, determining one or more carrier wave frequencies associated with a configured device-to-reader (D2R) channel of an ambient IoT system bandwidth. At 1020, the method includes transmitting a carrier wave having frequency components corresponding to the one or more carrier wave frequencies. In some examples, the method includes receiving configuration of the configured D2R channel in licensed New Radio spectrum from a base station.

In some examples, the carrier wave is a single tone sinusoidal wave. In these examples, the method may include determining the carrier wave frequency associated with the configured D2R channel as a center frequency of the configured D2R channel or a configured New Radio orthogonal frequency division multiplexing (OFDM) tone adjacent to a center frequency of the configured D2R channel. The method may include determining the carrier wave frequency associated with the configured D2R channel as a center frequency of the ambient IoT system bandwidth or as a center frequency of a portion of the ambient IoT system bandwidth that includes the configured D2R channel.

In other examples, the carrier wave is an orthogonal frequency division multiplexed (OFDM) carrier wave carrying a sequence of OFDM symbols.

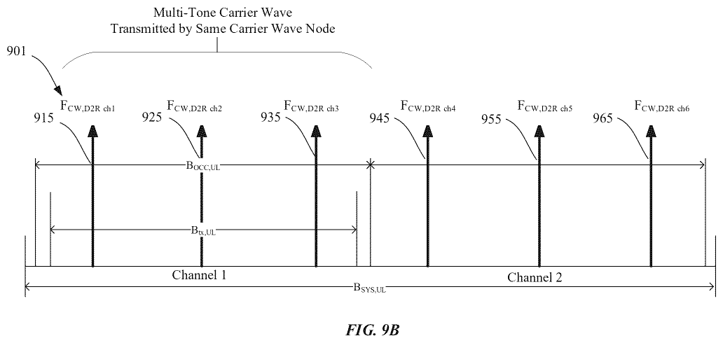

FIG. 11 is a flow diagram outlining an example method 1100 for receiving and decoding a D2R signal. The method 1100 may be performed by a reader device 220 of FIG. 2 or 320 or FIG. 3. The method includes, at 1110, controlling a receiver based on configuration of a D2R channel. At 1120, a reflected modulated carrier wave is received and filtered based the configured D2R channel. At 1130, the filtered reflected modulated carrier wave is decoded based on the configured D2R channel to recover D2R data.

In some examples, the carrier wave is a single tone sinusoidal wave. In these examples, the carrier wave frequency associated with the configured D2R channel may be a center frequency of the configured D2R channel or a configured New Radio orthogonal frequency division multiplexing (OFDM) tone adjacent to a center frequency of the configured D2R channel. In these examples, the method may include decoding each symbol of D2R data based on a coding scheme and a coding chip rate based on a symbol rate of the configured D2R data

The carrier wave frequency associated with the configured D2R channel may be a center frequency of the ambient IoT system bandwidth or a center frequency of a portion of the ambient IoT system bandwidth that includes the configured D2R channel. In these examples, the method may include decoding each symbol of D2R data based on a coding scheme and a coding chip rate, wherein the coding chip rate is based on the configured D2R channel.

In some examples, the modulated carrier wave is a modulated sinusoidal wave comprising multiple tones, and the respective tones of the multiple tones correspond to center frequencies of respective configured D2R channels of the ambient IoT system bandwidth. In these examples, the method may include filtering the modulated carrier wave based on the configured D2R channel.

In other examples, the carrier wave is an orthogonal frequency division multiplexed (OFDM) carrier wave carrying a sequence of OFDM symbols. In these examples, the method may include decoding the D2R data based on modulation each OFDM symbol in the modulated carrier wave.

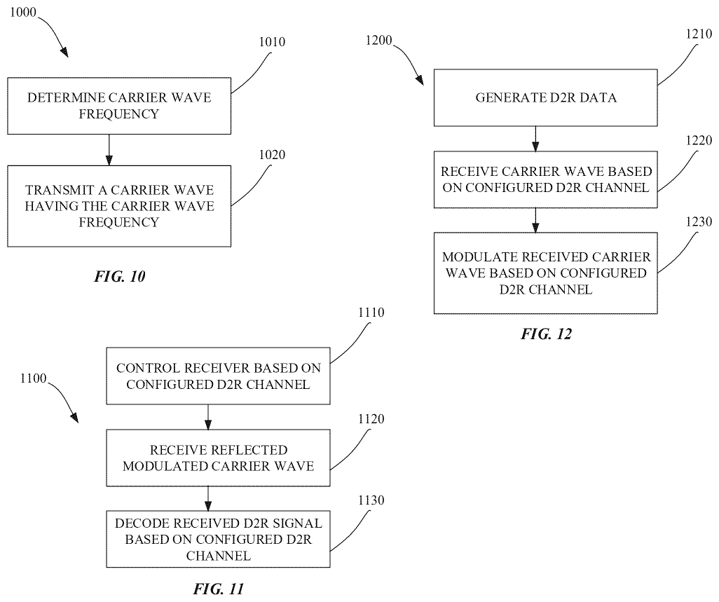

FIG. 12 is a flow diagram outlining an example method 1200 for encoding and transmitting a D2R signal. The method 1200 may be performed by an ambient IoT device 210 of FIG. 2 or 310 or FIG. 3. The method includes, at 1210, generating device to reader (D2R) data. At 1220, a carrier wave is received based on a configured device to reader (D2R) channel in an ambient IoT system bandwidth of New Radio licensed spectrum. At 1230, the method includes modulating the received carrier wave based on the D2R data to generate a modulated carrier wave.

In some examples, the method includes encoding each symbol of the D2R data based on a coding chip rate related to a symbol rate of the D2R data. In some examples, the method includes encoding the D2R symbols at half the symbol rate of the D2R data. In some examples, the coding chip rate is based on the configured D2R channel.

In some examples, the method includes modulating each OFDM symbol in the received carrier wave based on the D2R data.

Above are several flow diagrams outlining example methods and exchanges of messages. In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term encode when used with reference to some entity or value of an entity is to be construed broadly as encompassing any manner or technique for generating a data sequence or signal that communicates the entity to another component.

As used herein, the term select when used with reference to some entity or value of an entity is to be construed broadly as encompassing any manner of determining the entity or value of the entity from amongst a plurality or range of possible choices. For example, the term select is to be construed to encompass accessing and reading memory (e.g., lookup table, register, device memory, remote memory, and so on) that stores the entities or values for the entity and returning one entity or entity value from amongst those stored. The term select is to be construed as applying one or more constraints or rules to an input set of parameters to determine an appropriate entity or entity value. The term select is to be construed as broadly encompassing any manner of choosing an entity based on one or more parameters or conditions.

As used herein, the term derive when used with reference to some entity or value of an entity is to be construed broadly. “Derive” should be construed to encompass accessing and reading memory (e.g., lookup table, register, device memory, remote memory, and so on) that stores some initial value or foundational values and performing processing and/or logical/mathematical operations on the value or values to generate the derived entity or value for the entity. The term derive should be construed to encompass computing or calculating the entity or value of the entity based on other quantities or entities. The term derive should be construed to encompass any manner of deducing or identifying an entity or value of the entity.

As used herein, the term indicate when used with reference to some entity (e.g., parameter or setting) or value of an entity is to be construed broadly as encompassing any manner of communicating the entity or value of the entity either explicitly or implicitly. For example, bits within a transmitted message may be used to explicitly encode an indicated value or may encode an index or other indicator that is mapped to the indicated value by prior configuration. The absence of a field within a message may implicitly indicate a value of an entity based on prior configuration.

### EXAMPLES

Example 1 is a baseband processor, configured to perform operations including determining one or more carrier wave frequencies associated with a configured device-to-reader (D2R) channel of an ambient IoT system bandwidth; and controlling a radio frequency (RF) front end circuitry to transmit a carrier wave having frequency components corresponding to the one or more carrier wave frequencies.

Example 2 includes the subject matter of example 1, including or omitting optional elements, wherein the operations include receiving configuration of the configured D2R channel in licensed New Radio spectrum from a base station.

Example 3 includes the subject matter of any of examples 1-2, including or omitting optional elements, wherein the carrier wave is a single tone sinusoidal wave and wherein the operations include determining the carrier wave frequency associated with the configured D2R channel as a center frequency of the configured D2R channel.

Example 4 includes the subject matter of any of examples 1-2, including or omitting optional elements, wherein the carrier wave is a single tone sinusoidal wave, and wherein the operations include determining the carrier wave frequency associated with the configured D2R channel based on a configured New Radio orthogonal frequency division multiplexing (OFDM) tone adjacent to a center frequency of the configured D2R channel.

Example 5 includes the subject matter of any of examples 1-2, including or omitting optional elements, wherein the carrier wave is a single tone sinusoidal wave and wherein the operations include determining the carrier wave frequency associated with the configured D2R channel as a center frequency of the ambient IoT system bandwidth.

Example 6 includes the subject matter of any of examples 1-2, including or omitting optional elements, wherein the carrier wave is a single tone sinusoidal wave and wherein the operations include determining the carrier wave frequency associated with the configured D2R channel as a center frequency of a portion of the ambient IoT system bandwidth that includes the configured D2R channel.

Example 7 includes the subject matter of any of examples 1-2, including or omitting optional elements, wherein the carrier wave is a sinusoidal wave including multiple tones and wherein the operations include determining the carrier wave frequencies associated with the configured D2R channel as respective center frequencies of respective configured D2R channels of the ambient IoT system bandwidth.

Example 8 includes the subject matter of any of examples 1-2, including or omitting optional elements, wherein the carrier wave is an orthogonal frequency division multiplexed (OFDM) carrier wave carrying a sequence of OFDM symbols.

Example 9 is a reader device, including a receiver configured to receive and filter a reflected modulated carrier wave based on a configured device to reader (D2R) channel of an ambient IoT system bandwidth; and a baseband processor configured to control the receiver based on configuration of the D2R channel, and decode the filtered reflected modulated carrier wave based on the configured D2R channel to recover D2R data.

Example 10 includes the subject matter of example 9, including or omitting optional elements, wherein the modulated carrier wave is a modulated single tone sinusoidal wave having a carrier wave frequency corresponding to a center frequency of the configured D2R channel.

Example 11 includes the subject matter of example 9, including or omitting optional elements, wherein the modulated carrier wave is a modulated single tone sinusoidal wave having a carrier wave frequency based on a configured New Radio orthogonal frequency division multiplexing (OFDM) tone adjacent to a center frequency of the configured D2R channel.

Example 12 includes the subject matter of any of examples 10 or 11, including or omitting optional elements, wherein the D2R data includes one or more symbols and the baseband processor is configured to decode each symbol based on a coding scheme and a coding chip rate based on a symbol rate of the D2R data.

Example 13 includes the subject matter of example 9, including or omitting optional elements, wherein the modulated carrier wave is a modulated single tone sinusoidal wave having a carrier wave frequency corresponding to a center frequency of the ambient IoT system bandwidth.

Example 14 includes the subject matter of example 9, including or omitting optional elements, wherein the modulated carrier wave is a modulated single tone sinusoidal wave having a carrier wave frequency corresponding to a center frequency of a portion of the ambient IoT system bandwidth that includes the configured D2R channel.

Example 15 includes the subject matter of any of examples 13 or 14, including or omitting optional elements, wherein the D2R data includes one or more symbols and the baseband processor is configured to decode each symbol based on a coding scheme and a coding chip rate, wherein the coding chip rate is based on the configured D2R channel.

Example 16 includes the subject matter of example 9, including or omitting optional elements, wherein the modulated carrier wave is a modulated sinusoidal wave including multiple tones, respective tones of the multiple tones correspond to center frequencies of respective configured D2R channels of the ambient IoT system bandwidth, and the receiver is configured to filter the modulated carrier wave based on the configured D2R channel.

Example 17 includes the subject matter of example 9, including or omitting optional elements, wherein the carrier wave is a modulated orthogonal frequency division multiplexed (OFDM) carrier wave carrying a sequence of OFDM symbols and receiver is configured to decode the D2R data based on modulation each OFDM symbol in the modulated carrier wave.

Example 18 is an ambient Internet of Things (IoT) device, including a baseband processor configured to generate device to reader (D2R) data; and front end circuitry coupled to the baseband processor, including a backscatter transceiver configured to receive a carrier wave based on a configured device to reader (D2R) channel in an ambient IoT system bandwidth of New Radio licensed spectrum, control circuitry configured to control the backscatter transceiver to modulate the received carrier wave based on the D2R data to generate a modulated carrier wave.

Example 19 includes the subject matter of example 18, including or omitting optional elements, wherein the control circuitry is configured to encode each symbol of the D2R data based on a coding chip rate, wherein the coding chip rate is related to a symbol rate of the D2R data.

Example 20 includes the subject matter of example 19, including or omitting optional elements, wherein the control circuitry is configured to encode the D2R symbols at half the symbol rate of the D2R data.

Example 21 includes the subject matter of example 18, including or omitting optional elements, wherein the control circuitry is configured to encode each symbol of the D2R data based on a coding chip rate, wherein the coding chip rate is based on the configured D2R channel.

Example 22 includes the subject matter of example 18, including or omitting optional elements, wherein the carrier wave is an orthogonal frequency division multiplexed (OFDM) carrier wave carrying a sequence of OFDM symbols and the control circuitry is configured to modulate each OFDM symbol based on the D2R data.

Example 23 is the baseband processor of any of examples 9-22.

Example 24 is a method including operations performed by the device of any of examples 1-22.

Example 38 is a UE including the baseband processor of any of examples 1-8.

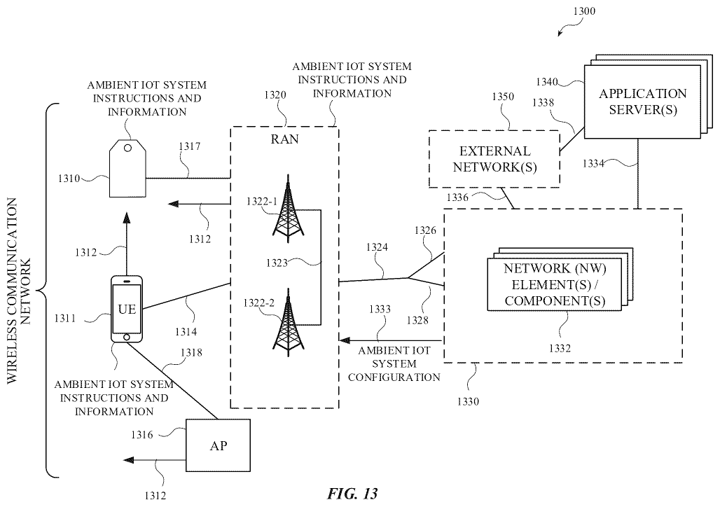

FIG. 13 is an example network 1300 providing an ambient IoT system according to one or more implementations described herein. Example network 1300 may include an ambient IoT device 1310, a UE 1311, a radio access network (RAN) 1320, a core network (CN) 1330, application servers 1340, and external networks 1350.

The systems and devices of example network 1300 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 1300 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, the UE 1311 may include a smartphone (e.g., handheld touchscreen mobile computing devices connectable to one or more wireless communication networks). Additionally, or alternatively, the UE 1311 may include other types of mobile or non-mobile computing devices capable of wireless communications, such as personal data assistants (PDAs), pagers, laptop computers, desktop computers, wireless handsets, watches etc.

The ambient IoT device 1310 may comprise a network access layer designed for low-power IoT applications utilizing short-lived UE connections. The ambient IoT device 1310 may store ambient IoT system instructions and information that enable the device 1310 to modulate a received carrier wave 1312 to generate a D2R signal for transmission in channel 1317.

Additionally, or alternatively, an IoT device may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

The UE 1311 may include stored ambient IoT system instructions and information that enable the UE 1311 to transmit a carrier wave 1312 for use by the ambient IoT device.

The UE 1311 may communicate and establish a connection with (e.g., be communicatively coupled) with RAN 1320, which may involve a wireless channel that carriers a D2R signal 1314, which may comprise a physical communications interface/layer. The UE 1311 may receive a carrier wave configuration by way of channel 1314 that provides information for use in generating a carrier wave for use by the ambient IoT device 1310.

As shown, UE 1311 may also, or alternatively, connect to access point (AP) 1316 via connection interface 1318, which may include an air interface enabling UE 1311 to communicatively couple with AP 1316. AP 1316 may comprise a wireless local area network (WLAN), WLAN node, WLAN termination point, etc. The connection 1318 may comprise a local wireless connection, such as a connection consistent with any IEEE 702.11 protocol, and AP 1316 may comprise a wireless fidelity (Wi-Fi®) router or other AP. While not explicitly depicted in FIG. 13, AP 1316 may be connected to another network (e.g., the Internet) without connecting to RAN 1320 or CN 1330. The UE 1311 may store ambient IoT instructions and information for acting as a carrier wave node or a reader node according to any of the solutions disclosed with reference to FIGS. 2-12. The access point 1316 may be configured to transmit a carrier wave 1312 for use by the ambient IoT device 1310.

RAN 1320 may include one or more RAN nodes 1322-1 and 1322-2 (referred to collectively as RAN nodes 1322, and individually as RAN node 1322) that enable channel 1314 to be established between the UE 1311 and RAN 1320. RAN nodes 1322 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, cNodeB, cNB, 4G base station, etc.), a next generation base station (e.g., a 5G base station, NR base station, next generation eNBs (gNB), etc.). RAN nodes 1322 may include a roadside unit (RSU), a transmission reception point (TRxP or TRP), and one or more other types of ground stations (e.g., terrestrial access points). In some scenarios, RAN node 1322 may be a dedicated physical device, such as a macrocell base station, and/or a low power (LP) base station for providing femtocells, picocells or the like having smaller coverage areas, smaller user capacity, or higher bandwidth compared to macrocells. Additionally, or alternatively, one or more of RAN nodes 1322 can be next generation eNBs (i.e., gNBs) that can provide evolved universal terrestrial radio access (E-UTRA) user plane and control plane protocol terminations 1326, 1328 toward UEs 1311, and that can be connected to a 5G core network (5GC) 130 via an NG interface 1324.

Any of the RAN nodes 1322 can terminate an air interface protocol and can be the first point of contact for UEs 1311. In some implementations, any of the RAN nodes 1322 can fulfill various logical functions for the RAN 1320 including, but not limited to, radio network controller (RNC) functions such as radio bearer management, uplink and downlink dynamic radio resource management and data packet scheduling, and mobility management. UE 1311 can be configured to communicate using orthogonal frequency-division multiplexing (OFDM) communication signals with each other or with any of the RAN nodes 1322 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations are not necessarily limited in this regard. The OFDM signals can comprise a plurality of orthogonal subcarriers. As described herein, the RAN nodes 1322 may be configured by an ambient IoT system configuration 1333 and store ambient IoT system instructions and information to enable a RAN node to act as a reader device to receive device to read (D2R) signals 1314 from the ambient IoT device 1310. The RAN nodes 1322 may also be configured by the ambient IoT system configuration 1333 and ambient IoT system instructions and information to transmit a carrier wave 1312 for use by the ambient IoT device 1310.

In some implementations, a downlink resource grid may be used for downlink transmissions from any of the RAN nodes 1322 to UEs 1311, and uplink transmissions may utilize similar techniques. The grid may be a time-frequency grid (e.g., a resource grid or time-frequency resource grid) that represents the physical resource for downlink in each slot.

Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

The RAN nodes 1322 may be configured to communicate with one another via interface 1323. In implementations where the system is an LTE system, interface 1323 may be an X2 interface. In NR systems, interface 1323 may be an Xn interface. The X2 interface may be defined between two or more RAN nodes 1322 (e.g., two or more cNBs/gNBs or a combination thereof) that connect to evolved packet core (EPC) or CN 1330, or between two eNBs connecting to an EPC.

CN 1330 may comprise a plurality of network elements 1332, which are configured to offer various data and telecommunications services to customers/subscribers (e.g., users of UEs 1311) who are connected to the CN 1330 via the RAN 1320. In some implementations, CN 1330 may include an evolved packet core (EPC), a 5G CN, and/or one or more additional or alternative types of CNs. The components of the CN 1330 may be implemented in one physical node or separate physical nodes including components to read and execute instructions from a machine-readable or computer-readable medium (e.g., a non-transitory machine-readable storage medium.

As shown, CN 1330, application servers 1340, and external networks 1350 may be connected to one another via interfaces 1334, 1336, and 1338, which may include IP network interfaces.

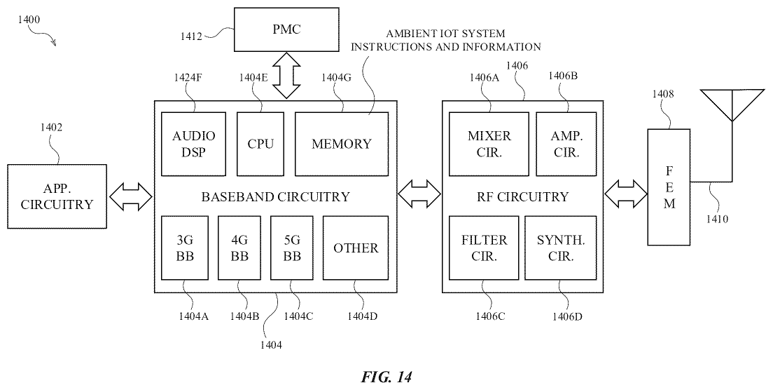

FIG. 14 is a diagram of an example of components of a device according to one or more implementations described herein. In some implementations, the device 1400 can include application circuitry 1402, baseband circuitry 1404, RF circuitry 1406, front-end module (FEM) circuitry 1408, one or more antennas 1410, and power management circuitry (PMC) 1412 coupled together at least as shown. The components of the illustrated device 1400 can be included in a UE or a RAN node serving as a carrier wave node and/or a reader node in an ambient IoT system. In some implementations, the device 1400 can include fewer elements (e.g., a RAN node may not utilize application circuitry 1402, and instead include a processor/controller to process IP data received from a CN or an Evolved Packet Core (EPC)). In some implementations, the device 1400 can include additional elements such as, for example, memory/storage, display, camera, sensor (including one or more temperature sensors, such as a single temperature sensor, a plurality of temperature sensors at different locations in device 1400, etc.), or input/output (I/O) interface. In other implementations, the components described below can be included in more than one device (e.g., said circuitries can be separately included in more than one device for Cloud-RAN (C-RAN) implementations).

The baseband circuitry 1404 can include circuitry such as, but not limited to, one or more single-core or multi-core processors. The baseband circuitry 1404 can include one or more baseband processors or control logic to process baseband signals received from a receive signal path of the RF circuitry 1406 and to generate baseband signals for a transmit signal path of the RF circuitry 1406. Baseband circuitry 1404 can interface with the application circuitry 1402 for generation and processing of the baseband signals and for controlling operations of the RF circuitry 1406. For example, in some implementations, the baseband circuitry 1404 can include a 3G baseband processor 1404A, a 4G baseband processor 1404B, a 5G baseband processor 1404C, or other baseband processor(s) 1404D for other existing generations, generations in development or to be developed in the future (e.g., 5G, 6G, etc.).

The baseband circuitry 1404 (e.g., one or more of baseband processors 1404A-D) can handle various radio control functions that enable communication with one or more radio networks via the RF circuitry 1406. In other implementations, some or all of the functionality of baseband processors 1404A-D can be included in modules stored in the memory 1404G and executed via a Central Processing Unit (CPU) 1404E. The radio control functions can include, but are not limited to, signal modulation/demodulation, encoding/decoding, radio frequency shifting, etc. In some implementations, modulation/demodulation circuitry of the baseband circuitry 1404 can include Fast-Fourier Transform (FFT), precoding, or constellation mapping/de-mapping functionality. In some implementations, encoding/decoding circuitry of the baseband circuitry 1404 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 1404G may receive and/or store ambient IoT system instructions and information for generating and transmitting a carrier wave or acting as an ambient IoT reader device according to any of the solutions disclosed herein.

In some implementations, the baseband circuitry 1404 can include one or more audio digital signal processor(s) (DSP) 1404F. The audio DSPs 1404F can include elements for compression/decompression and echo cancellation and can include other suitable processing elements in other implementations.

RF circuitry 1406 can enable communication with wireless networks using modulated electromagnetic radiation through a non-solid medium. In various implementations, the RF circuitry 1406 can include switches, filters, amplifiers, etc. to facilitate the communication with the wireless network. RF circuitry 1406 can include a receive signal path which can include circuitry to down-convert RF signals received from the FEM circuitry 1408 and provide baseband signals to the baseband circuitry 1404. RF circuitry 1406 can also include a transmit signal path which can include circuitry to up-convert baseband signals provided by the baseband circuitry 1404 and provide RF output signals to the FEM circuitry 1408 for transmission.

In some implementations, the receive signal path of the RF circuitry 1406 can include mixer circuitry 1406A, amplifier circuitry 1406B and filter circuitry 1406C. RF circuitry 1406 can also include synthesizer circuitry 1406D for synthesizing a frequency for use by the mixer circuitry 1406A of the receive signal path and the transmit signal path.

The RF circuitry 1406 can include analog-to-digital converter (ADC) and digital-to-analog converter (DAC) circuitry and the baseband circuitry 1404 can include a digital baseband interface to communicate with the RF circuitry 1406.

Synthesizer circuitry 1406D of the RF circuitry 1406 can include a divider, a delay-locked loop (DLL), a multiplexer and a phase accumulator.

FEM circuitry 1408 can include a receive signal path which can include circuitry configured to operate on RF signals received from one or more antennas 1410, amplify the received signals and provide the amplified versions of the received signals to the RF circuitry 1406 for further processing. FEM circuitry 1408 can also include a transmit signal path which can include circuitry configured to amplify signals for transmission provided by the RF circuitry 1406 for transmission by one or more of the one or more antennas 1410. In various implementations, the amplification through the transmit or receive signal paths can be done solely in the RF circuitry 1406, solely in the FEM circuitry 1408, or in both the RF circuitry 1406 and the FEM circuitry 1408.

In some implementations, the PMC 1412 can manage power provided to the baseband circuitry 1404. In particular, the PMC 1412 can control power-source selection, voltage scaling, battery charging, or DC-to-DC conversion. The PMC 1412 can often be included when the device 1400 is capable of being powered by a battery, for example, when the device is included in a UE. The PMC 1412 can increase the power conversion efficiency while providing desirable implementation size and heat dissipation characteristics.

While FIG. 14 shows the PMC 1412 coupled only with the baseband circuitry 1404. However, in other implementations, the PMC 1412 may be additionally or alternatively coupled with, and perform similar power management operations for, other components such as, but not limited to, application circuitry 1402, RF circuitry 1406, or FEM circuitry 1408.

In some implementations, the PMC 1412 can control, or otherwise be part of, various power saving mechanisms of the device 1400. For example, if the device 1400 is in an RRC_Connected state, where it is still connected to the RAN node as it expects to receive traffic shortly, then it can enter a state known as Discontinuous Reception Mode (DRX) after a period of inactivity. During this state, the device 1400 can power down for brief intervals of time and thus save power. During these intervals the device 1400 may periodically power up a low power receiver (see FIG. 1A) to monitor for a WUS.

If there is no data traffic activity for an extended period of time, then the device 1400 can transition off to an RRC_Idle state, where it disconnects from the network and does not perform operations such as channel quality feedback, handover, etc. The device 1400 goes into a very low power state and it performs paging where again it periodically wakes up to listen to the network and then powers down again.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

1. A baseband processor, configured to perform operations comprising:
determining one or more carrier wave frequencies associated with a configured device-to-reader (D2R) channel of an ambient IoT system bandwidth; and
controlling a radio frequency (RF) front end circuitry to transmit a carrier wave having frequency components corresponding to the one or more carrier wave frequencies.

2. The baseband processor of claim 1, wherein the operations comprise receiving configuration of the configured D2R channel in licensed New Radio spectrum from a base station.

3. The baseband processor of claim 1, wherein the carrier wave is a single tone sinusoidal wave and wherein the operations comprise determining the carrier wave frequency associated with the configured D2R channel as a center frequency of the configured D2R channel.

4. The baseband processor of claim 1, wherein
the carrier wave is a single tone sinusoidal wave, and
wherein the operations comprise determining the carrier wave frequency associated with the configured D2R channel based on a configured New Radio orthogonal frequency division multiplexing (OFDM) tone adjacent to a center frequency of the configured D2R channel.

5. The baseband processor of claim 1, wherein the carrier wave is a single tone sinusoidal wave and wherein the operations comprise determining the carrier wave frequency associated with the configured D2R channel as a center frequency of the ambient IoT system bandwidth.

6. The baseband processor of claim 1, wherein the carrier wave is a single tone sinusoidal wave and wherein the operations comprise determining the carrier wave frequency associated with the configured D2R channel as a center frequency of a portion of the ambient IoT system bandwidth that includes the configured D2R channel.

7. The baseband processor of claim 1, wherein the carrier wave is a sinusoidal wave comprising multiple tones and wherein the operations comprise determining the carrier wave frequencies associated with the configured D2R channel as respective center frequencies of respective configured D2R channels of the ambient IoT system bandwidth.

8. The baseband processor of claim 1, wherein the carrier wave is an orthogonal frequency division multiplexed (OFDM) carrier wave carrying a sequence of OFDM symbols.

9. A reader device, comprising:
a receiver configured to receive and filter a reflected modulated carrier wave based on a configured device to reader (D2R) channel of an ambient IoT system bandwidth; and
a baseband processor configured to
control the receiver based on configuration of the D2R channel, and
decode the filtered reflected modulated carrier wave based on the configured D2R channel to recover D2R data.

10. The reader device of claim 9, wherein the modulated carrier wave is a modulated single tone sinusoidal wave having a carrier wave frequency corresponding to a center frequency of the configured D2R channel.

11. The reader device of claim 9, wherein the modulated carrier wave is a modulated single tone sinusoidal wave having a carrier wave frequency based on a configured New Radio orthogonal frequency division multiplexing (OFDM) tone adjacent to a center frequency of the configured D2R channel.

12. The reader device of claim 10, wherein the D2R data comprises one or more symbols and the baseband processor is configured to decode each symbol based on a coding scheme and a coding chip rate based on a symbol rate of the D2R data.

13. The reader device of claim 9, wherein the modulated carrier wave is a modulated single tone sinusoidal wave having a carrier wave frequency corresponding to a center frequency of the ambient IoT system bandwidth.

14. The reader device of claim 9, wherein the modulated carrier wave is a modulated single tone sinusoidal wave having a carrier wave frequency corresponding to a center frequency of a portion of the ambient IoT system bandwidth that includes the configured D2R channel.

15. The reader device of claim 13, wherein the D2R data comprises one or more symbols and the baseband processor is configured to decode each symbol based on a coding scheme and a coding chip rate, wherein the coding chip rate is based on the configured D2R channel.

16. The reader device of claim 9 wherein
the modulated carrier wave is a modulated sinusoidal wave comprising multiple tones,
respective tones of the multiple tones correspond to center frequencies of respective configured D2R channels of the ambient IoT system bandwidth, and
the receiver is configured to filter the modulated carrier wave based on the configured D2R channel.

17. The reader device of claim 9, wherein the carrier wave is a modulated orthogonal frequency division multiplexed (OFDM) carrier wave carrying a sequence of OFDM symbols and receiver is configured to decode the D2R data based on modulation each OFDM symbol in the modulated carrier wave.

18. An ambient Internet of Things (IoT) device, comprising:
a baseband processor configured to generate device to reader (D2R) data; and
front end circuitry coupled to the baseband processor, comprising
a backscatter transceiver configured to receive a carrier wave based on a configured device to reader (D2R) channel in an ambient IoT system bandwidth of New Radio licensed spectrum, and
control circuitry configured to control the backscatter transceiver to modulate the received carrier wave based on the D2R data to generate a modulated carrier wave.

19. The ambient IoT device of claim 18, wherein the control circuitry is configured to encode each symbol of the D2R data based on a coding chip rate, wherein the coding chip rate is related to a symbol rate of the D2R data or the configured D2R channel.

20. The ambient IoT device of claim 18, wherein the carrier wave is an orthogonal frequency division multiplexed (OFDM) carrier wave carrying a sequence of OFDM symbols and the control circuitry is configured to modulate each OFDM symbol based on the D2R data.
